(19) United States
(12) Patent Application Publication
(10) Pub. No.: US 2008/0292009 A1
(43) Pub. Date: Nov. 27, 2008

(54) MULTIPLE-INPUT-MULTIPLE-OUTPUT WIRELESS TRANSMISSION SYSTEM AND TRANSMISSION METHOD THEREOF

(75) Inventors: Juinn-Hurng Deng, TAOYUAN COUNTY (TW); Jeng-Kuang Hwang, TAOYUAN COUNTY (TW); Yu-Min Chuang, HSINCHU CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: CHUNG SHAN INSTITUTE OF SCIENCE AND TECHNOLOGY, ARMAMENTS BUREAU, M.N.D., TAOYUAN COUNTY (TW)

(21) Appl. No.: 11/776,000

(22) Filed: Jul. 11, 2007

(30) Foreign Application Priority Data
May 24, 2007 (TW) 096118551

(51) Int. Cl. H04K 1/10

(52) U.S. Cl. 375/260

(57) ABSTRACT

The present invention relates to a multiple-input-multiple-output (MIMO) wireless transmission system and a transmission method thereof. A wireless transmitting system thereof receives encoded data via a first processing unit, which processes the encoded data and outputs the encoded data to a plurality of modulation units for modulating the encoded data to produce a plurality of modulated data. A plurality of first conversion units converts the plurality of modulated data to a plurality of transmitting signals. A plurality of radio-frequency (RF) circuits receives the plurality of transmitting signals and transmits RF signals according to the frequency-hopping sequence of a piconet. A plurality of receiving processing units of a wireless receiving system according to the present invention receives the RF signals, respectively, according to the frequency-hopping sequence of the piconet and transmits to a plurality of second conversion units for converting the RF signals to received data. A switching circuit switches the received data according to the frequency-hopping sequence of the piconet. A plurality of demodulation units demodulates the switched received data to produce demodulated data. A second processing unit received the demodulated data, and processes the demodulated data to output demodulated data. A decoding unit decodes the demodulated data output by the second processing unit to produce output data.

### FIELD OF THE INVENTION

The present invention relates generally to a wireless transmission system and a transmission method thereof, and particularly to a multiple-input-multiple-output (MIMO) wireless transmission system and a transmission method thereof.

### BACKGROUND OF THE INVENTION

In modern society with advanced technologies, electronic products continuously weed through the old to bring forth the new. The importance of wireless communication services rises day by day. The requests for higher network capacity and higher performance keep growing unceasingly. In addition, the demands for wide bandwidth of wireless communication and high data rate have become future goals.

Presently, the ultra wideband (UWB) system appeals people's attention, and has been regarded as a solution for short-distance wireless communications. The advantages thereof include high data rate, low power, and low cost. Besides, international organizations have proposed two technologies currently to meet the UWB requirements: multi-band orthogonal frequency-division (MB-OFDM) technology and direct-sequence code-division multiple access (DS-CDMA) technology. Because MB-OFDM technology owns the capability of utilizing the spectrum flexibly and of supporting seven piconets with different frequency-hopping methods, it can meet the spectrum requirements of various countries in the world. In addition, people in the future will require multimedia data transmission with even higher quality or speed.

Furthermore, a general multiple-input-multiple-output (MIMO) wireless transmission system adopts multiple sets of transmission antennas for achieving the purpose of fast data transmission. However, because a general MIMO wireless transmission system uses multiple sets of transmission antennas in the same band, the transmission is subject to interference from each other, which makes error data receiving. In order to avoid error data receiving or receiving data transmitted from wrong antennas, the complexity of circuits in the receiver system is increased.

Accordingly, a multiple-input-multiple-output (MIMO) wireless transmission system and a transmission method thereof, which combine the characteristics of multiple antennas and piconets to achieve the requirements of higher quality or high-speed transmission, as well as reducing system complexity by adopting spatial multiplexing with noninterference characteristic, are provided.

### SUMMARY

An objective of the present invention is to provide a multiple-input-multiple-output (MIMO) wireless transmission system and a transmission method thereof, which combine the antenna and the frequency-hopping characteristics of MIMO to make each antenna transmit data in different bands. Thereby, the present invention can feature spatial frequency-hopping multiplexing, and the purpose of high-speed transmission can be achieved.

Another objective of the present invention is to provide a MIMO wireless transmission system and a transmission method thereof. Each antenna of the wireless transmitting system transmits data in the same band for achieving the purpose of high-quality transmission.

A further objective of the present invention is to provide a MIMO wireless transmission system and a transmission method thereof. The circuits of the wireless transmission system are simple and thereby costs can be reduced.

Still another objective of the present invention is to provide a MIMO wireless transmission system and a transmission method thereof, which are compatible with the serial-in/serial-out multi-band orthogonal frequency-division (SISO MB-OFDM) system with serial inputs and outputs.

The MIMO wireless transmission system and the transmission method thereof according to the present invention includes a wireless transmitting system and a wireless receiving system. The wireless transmission system includes an encoding unit, a first processing unit, a plurality of modulation units, a plurality of first conversion units, and a plurality of radio-frequency (RF) circuits. The wireless receiving circuit includes a switching circuit, a plurality of receiving processing units, a plurality of second conversion units, a plurality of demodulation units, a second processing unit, and a decoding unit.

The encoding unit receives input data, and encodes the input data to produce encoded data. He first processing unit receives the encoded data, processes the encoded data, and outputs the encoded data. The plurality of modulation units receives the encoded data output by the first processing unit, and modulates the encoded data to produce a plurality of modulated data. The plurality of first conversion unit couples to the plurality of modulation units, respectively, receives the plurality of modulated data, and converts it into a plurality of transmitting signals. The plurality of RF circuit couples to the plurality of first conversion units, respectively, receives the plurality of transmitting signals, converts it into a plurality of RF signals, and transmits the RF signals according to the frequency-hopping sequence of a piconet, respectively.

The plurality of receiving processing units receives the RF signals according to the frequency-hopping sequence of the piconet of the RF circuits, respectively. The plurality of second conversion units couples to the plurality of receiving processing units, respectively, receives the RF signals, and converts the RF signals to received data. The switching circuit switches the received data according to a selection signal. The plurality of demodulation units receives the received data switched by the switching circuit, and demodulates the received data to produce demodulated data. The second processing unit receives the demodulated data, and processes the demodulated data to output demodulated data. The decoding unit decodes the demodulated data output by the second processing unit to produce output data.

Moreover, the first processing unit processes the encoded data using spatial multiplexing, and outputs the encoded data to the plurality of modulation units for modulating the encoded data. Then the plurality of RF circuits transmits the RF signals switchingly to the plurality of receiving processing units according to the different bands of the frequency-hopping sequence of the piconet. Alternatively, the encoded data is processed by the spatial reuse process. Then, the plurality of RF circuits transmits the RF signals in parallel to the plurality of receiving processing units in the same band.

### BRIEF DESCRIPTION OF THE DRAWINGS

FIG. 1A shows the block diagram of a wireless transmission system according to a preferred embodiment of the present invention;

FIG. 1B shows the block diagram of a wireless receiving system according to a preferred embodiment of the present invention;

FIG. 2 shows the frequency-hopping sequence of a piconet;

FIG. 3A shows the frequency-hopping sequence of the first piconet of a MIMO system according to a preferred embodiment of the present invention;

FIG. 3B shows the frequency-hopping sequence of the second piconet of a MIMO system according to a preferred embodiment of the present invention;

FIG. 3C shows the frequency-hopping sequence of the third piconet of a MIMO system according to a preferred embodiment of the present invention;

FIG. 3D shows the frequency-hopping sequence of the fourth piconet of a MIMO system according to a preferred embodiment of the present invention;

FIG. 3E shows the frequency-hopping sequence of the fifth to the seventh piconet of a MIMO system according to a preferred embodiment of the present invention;

FIG. 4A shows the schematic diagram of MIMO data transmission according to a preferred embodiment of the present invention;

FIG. 4B shows the schematic diagram of MIMO data transmission according to another preferred embodiment of the present invention; and

FIG. 4C shows the schematic diagram of MIMO data transmission according to still another preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

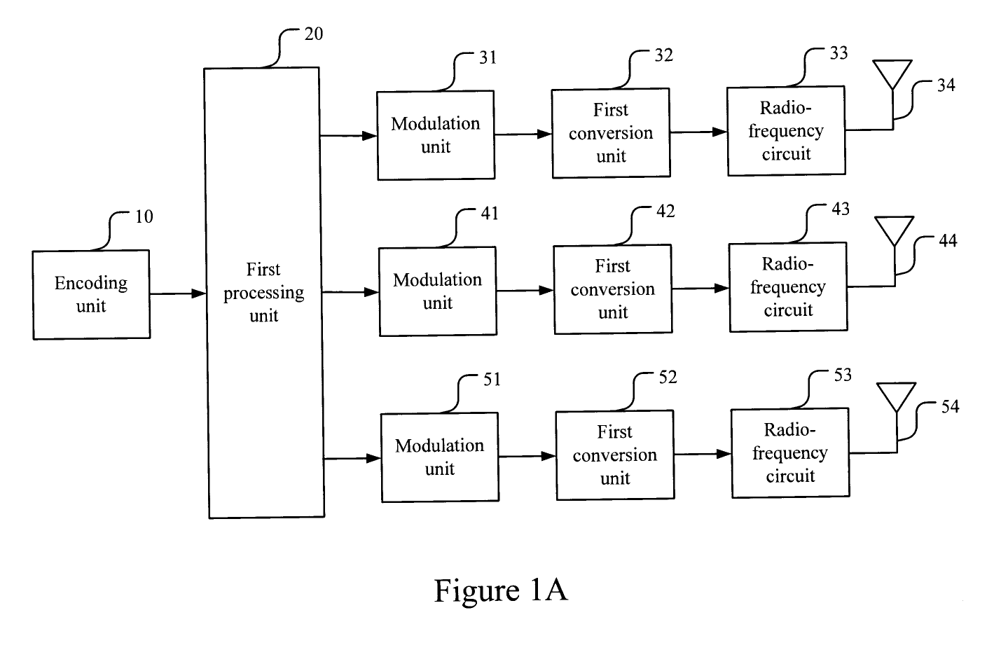

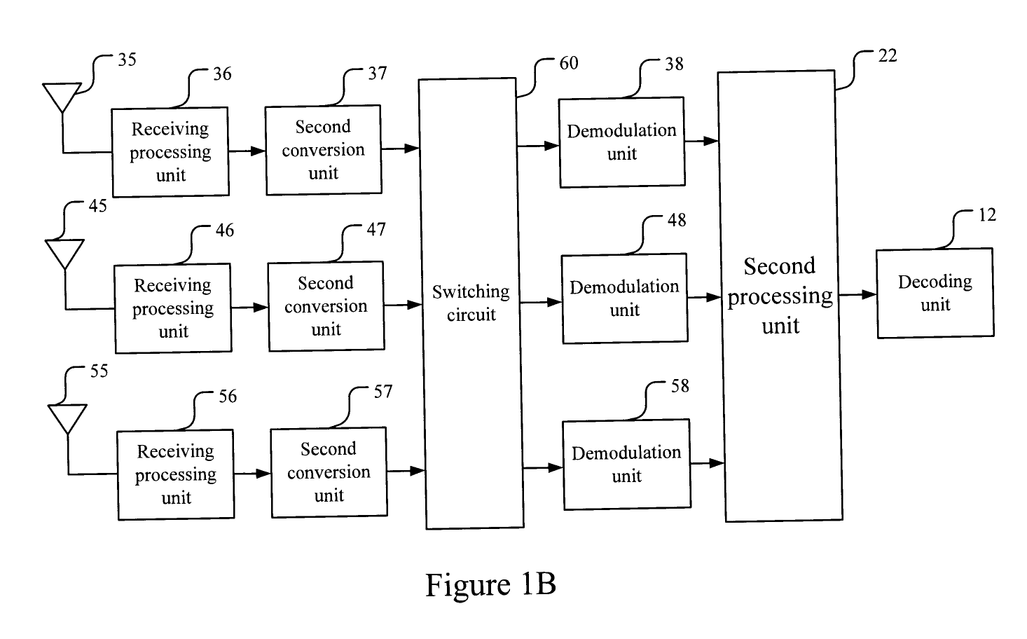

FIGS. 1A and 1B show the block diagrams according to a preferred embodiment of the present invention. As shown in the figures, the MIMO wireless transmission system includes a wireless transmitting system and a wireless receiving system. FIG. 1A shows the wireless transmitting system, while FIG. 1B shows the wireless receiving system. The wireless transmitting system includes an encoding unit 10, a first processing unit 20, a plurality of modulation units 31, 41, 51, a plurality of first conversion units 32, 42, 52, and a plurality of radio-frequency (RF) circuits 33, 43, 53. The encoding unit 10 receives input data, and encodes the input data to produce encoded data. The encoding unit 10 includes a scrambler, a Reed-Solomon encoder, and a convolutional encoder. This is well known by the person having ordinary skill in the art, and will not be described further in details.

The first processing unit 20 receives the encoded data, processes the encoded data, and transmits it to the plurality of modulation units 31, 41, 51, which modulates the encoded data to produce a plurality of modulated data. The modulation unit is an orthogonal frequency-division multiplexing (OFDM) modulation unit. In addition, the modulation units 31, 41, 51 include interleaver, mapping, and inverse fast Fourier transform (IFFT). This is well known by the person having ordinary skill in the art, and will not be described further in details.

The plurality of first conversion units 32, 42, 52 couples to the plurality of nodulation units 31, 41, 51, respectively, for receiving the plurality of modulation data transmitted by the plurality of modulation units 31, 41, 51, converting it to a plurality of transmitting signals, and then outputting to the RF circuits 33, 43, 53, respectively. The first conversion units 32, 42, 52 are digital-to-analog converters used for converting digital modulation signals to analog RF signals. The RF circuits 33, 43, 53 receive the plurality of transmitting signals and convert them into a plurality of RF signals. Besides, the RF circuits 33, 43, 53 transmit RF signals according to the frequency-hopping sequence of a piconet, respectively. The RF circuits 33, 43, 53 include transmitting antennas 34, 44, 54, respectively, for transmitting the RF signals to the wireless receiving system.

A plurality of receiving processing units 36, 46, 56 of the wireless receiving system receives the RF signals according to the frequency-hopping sequence of the piconet of the plurality of RF circuits 33, 43, 53, respectively. The receiving processing units 36, 46, 56 include receiving antennas 35, 45, 55, respectively, for receiving the RF signals and transmitting to the plurality of receiving processing units 36, 46, 56. A plurality of second conversion units 37, 47, 57 couples to the plurality of receiving processing units 36, 46, 56, respectively, for receiving the RF signals and converting the RF signals into received data. The second conversion units 37, 47, 57 are analog-to-digital converters, used for converting analog RF signals to digital received data. A switching circuit 60 switches the received data. A plurality of demodulation units 38, 48, 58 receives the received data switched by the switching circuit 60, and demodulates the received data to produce demodulated data. The demodulation units 38, 48, 58 are OFDM demodulation units. A second processing unit 22 receives the demodulated data, and processes the demodulated data to produce demodulated data. A decoding unit 12 decodes the demodulated data to produce output data.

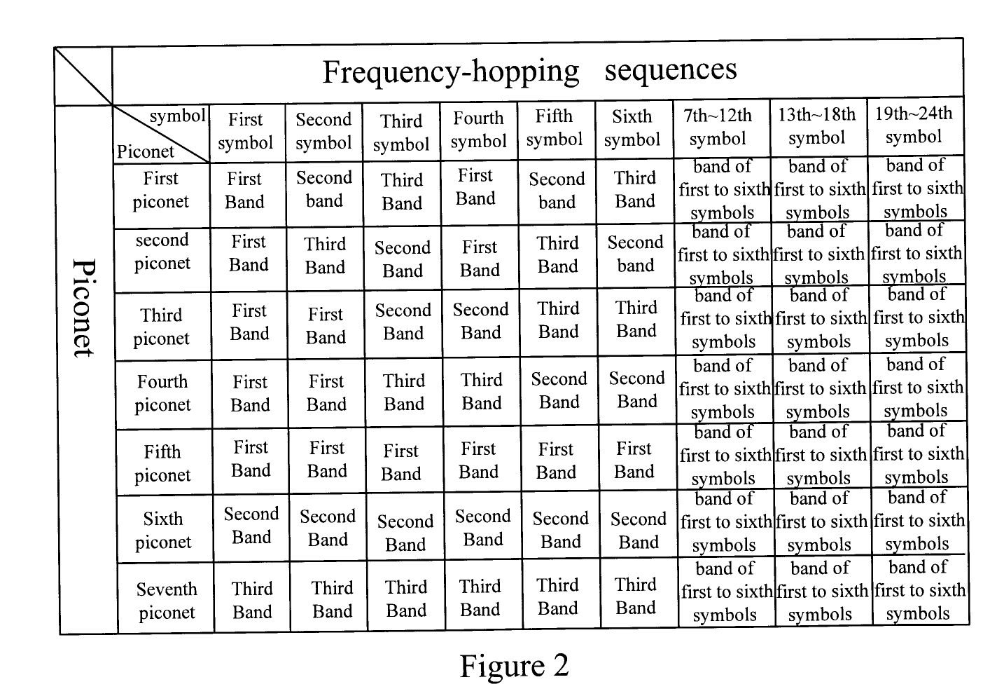

The first processing unit 20 processes the encoded data using spatial multiplexing and outputs the encoded data. That is, the first processing unit 20 is a demultiplexer, which transmits different encoded data sequentially to the modulation unit 31, respectively, for modulating the encoded data. Thereby, the second processing unit 22 behaves like a multiplexer, which restores spatial multiplexing and processes the demodulated data to output the demodulated data. The wireless transmitting system according the present preferred embodiment has three antennas 34, 44, 54. The function of the encoding unit 10 thereof behaves like the encoding unit of a SISO MB-OFDM system. However, when the first processing unit 20 according to the present preferred embodiment transmits data by spatial multiplexing, the encoding unit 10 needs to encode at the speed three times the encoding speed of a SISO MB-OFDM system. An MB-OFDM system has seven different piconets to choose from for transmitting packet data. In addition, for each symbol in each piconet, it is regulated that there are different frequency-hopping methods for transmitting data as shown in FIG. 2. It is known that for the first to the seventh piconets, six symbols form a frequency-hopping period. For example, in the first piconet, the frequency-hopping sequence is q(n)=[1 2 3 1 2 3 . . . ].

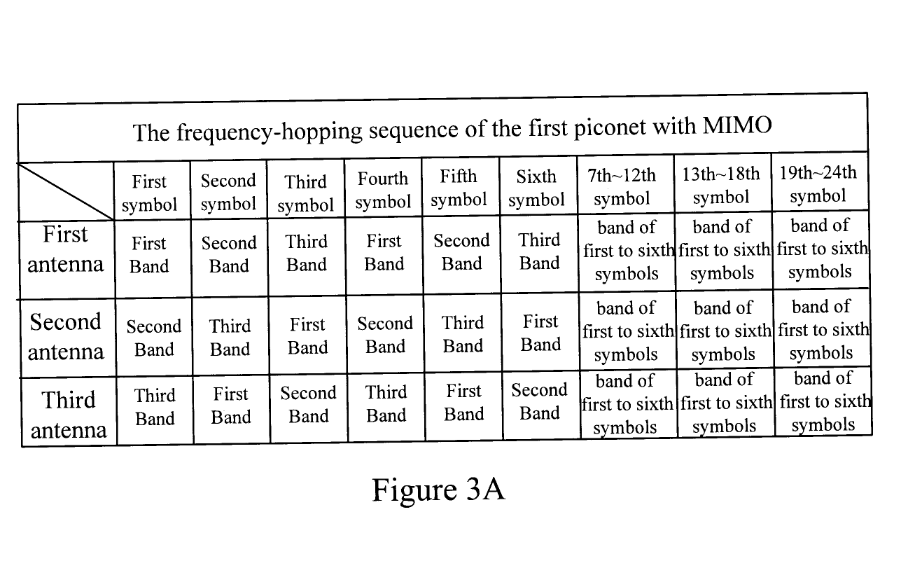

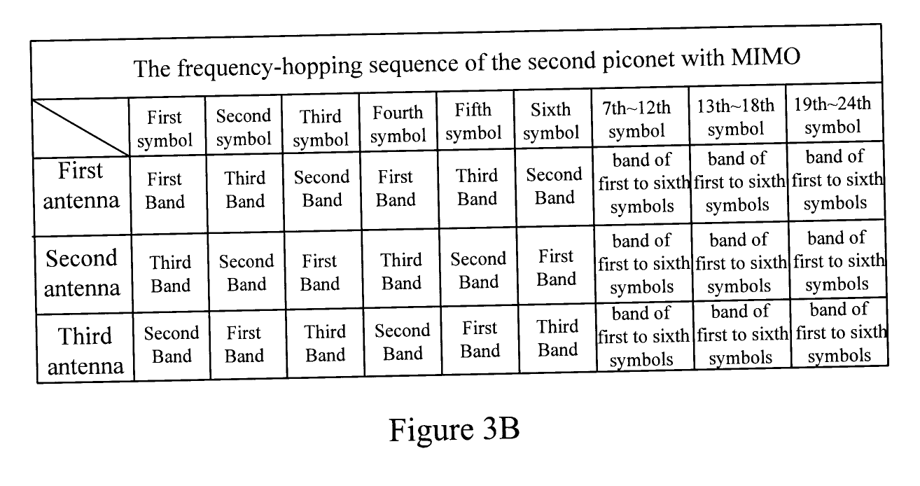

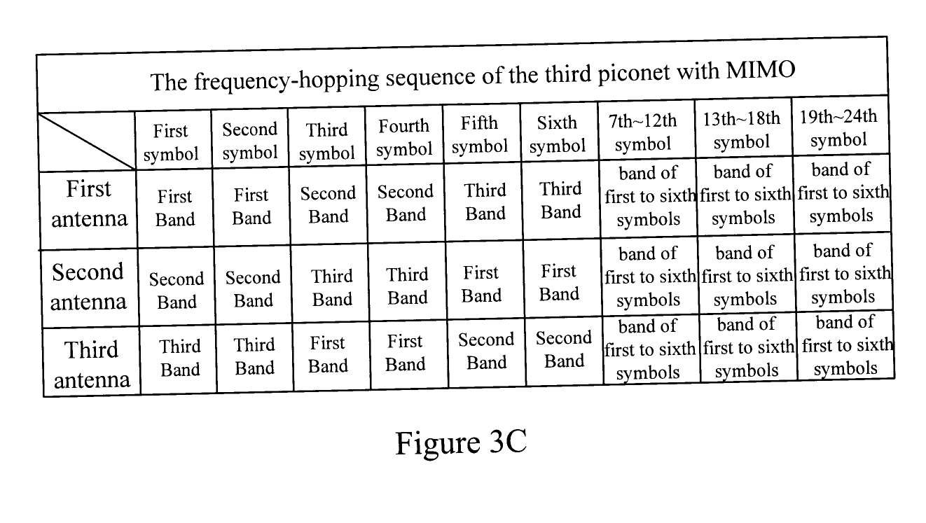

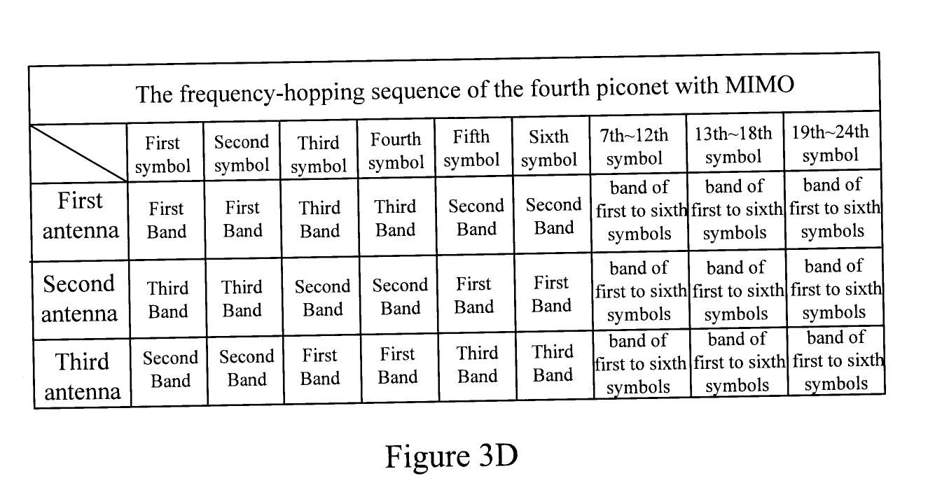

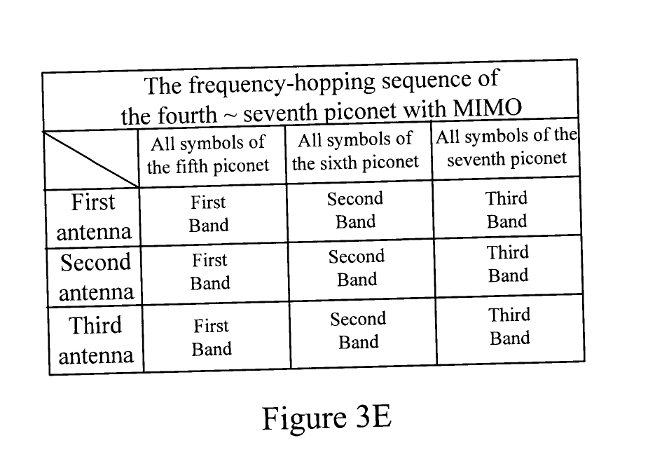

The present invention makes use of the allowable frequency-hopping bands of piconets described above in combination with the antenna framework of a MIMO system for achieving spatial multiplexing purpose. In the following, the first piconet is used as an example. FIG. 3A shows the frequency-hopping sequence of the first piconet of a MIMO system according to a preferred embodiment of the present invention. As shown in the figure, the wireless transmitting system according to the present invention has three transmitting antennas 34, 44, 54. In order to comply with the frequency-hopping sequence of the first piconet as well we to avoid being in the same band for the transmitted data by each antenna, in the first piconet, the second transmitting antenna 44 performs frequency hopping by lagging a symbol behind the first transmitting antenna 34, and the third transmitting antenna 54 performs frequency hopping by lagging a symbol behind the second transmitting antenna 44. That is, the frequency-hopping sequence of the first transmitting antenna 34 is q1(n)=[1 2 3 1 2 3 . . . ]; the frequency-hopping sequence of the second transmitting antenna 44 is q2(n)=[2 3 1 2 3 1 . . . ]; the frequency-hopping sequence of the third transmitting antenna 54 is q3(n)=[3 1 2 3 1 2 . . . ]. By the frequency-hopping method described above, it is known that the frequency-hopping bands of the first transmitting antenna 34 to the third transmitting antenna 54 do not interference with each other. If spatial multiplexing is used to transmit three different data independently, then the receiving system needs to adopt the existing SISO technology only for achieving high-speed data transmission, without the need of using complicated MIMO algorithms.

Likewise, FIGS. 3B to 3D show the frequency-hopping sequences of the second to the fourth piconets of a MIMO system according to a preferred embodiment of the present invention. As shown in the figures, the wireless transmitting system can transmit data by using the frequency-hopping sequence of the first piconet. The difference between the frequency-hopping sequences of the third piconet and of the fourth piconet is that the third and the fourth piconets hop to another band for every two symbols. Thereby, the transmitting antennas of the wireless transmitting system need to lag by two symbols for avoiding transmitting data in the same band by the transmitting antennas.

Because the frequency-hopping sequences of the fifth to the seventh piconets are confined only in the first to the third bands, respectively (as shown in FIG. 3E), the first processing unit 20 according to the present invention can process the encoded data in the spatial reuse method and then output the encoded data. That is, the first processing unit 20 can transmit the encoded data to the plurality of modulation units simultaneously for modulating the encoded data. Then the RF circuits 33, 43, 53 can transmit the RF signals simultaneously to the wireless receiving system. Thereby, diversified data by spatial and frequency-hopping methods can be given, which prevent data loss due to failure of data transmission occurred in any transmitting antenna. Besides, the second processing unit 22 behaves likes a synthesis unit, which restores the spatial reuse processes, and processes demodulated data to output demodulated data.

Moreover, the first processing unit 20 further receives a selection signal for selecting whether spatial multiplexing or the spatial reuse process on the encoded data is adopted by the first processing unit 20. The selection signal is a piconet selection signal. When the piconet selection signal is one of the first to the fourth piconets, the first processing unit 20 adopts spatial multiplexing method to process the encoded data, and the plurality of RF circuits 33, 43, 53 transmits switchingly the RF signals to the plurality of receiving processing units 36, 46, 56, respectively, according to the different bands of the frequency-hopping sequence of the piconets. On the other hand, when the piconet selection signal is one of the fifth to the seventh piconets, the first processing unit 20 adopts the spatial reuse method to process the encoded data, and the plurality of RF circuits 33, 43, 53 transmits in parallel the RF signals to the plurality of receiving processing units 36, 46, 56, respectively, according to the different bands of the frequency-hopping sequence of the piconets.

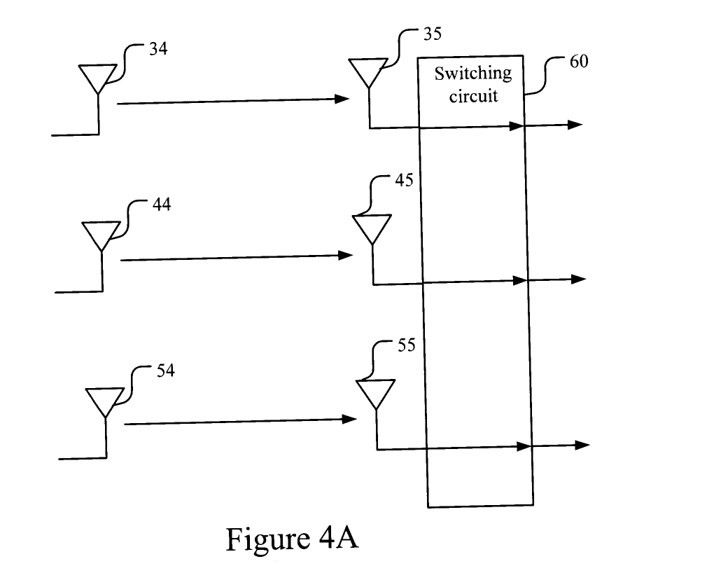

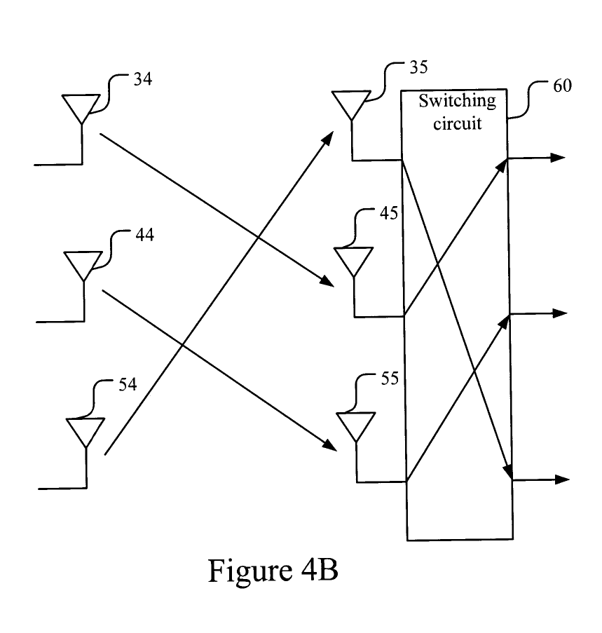

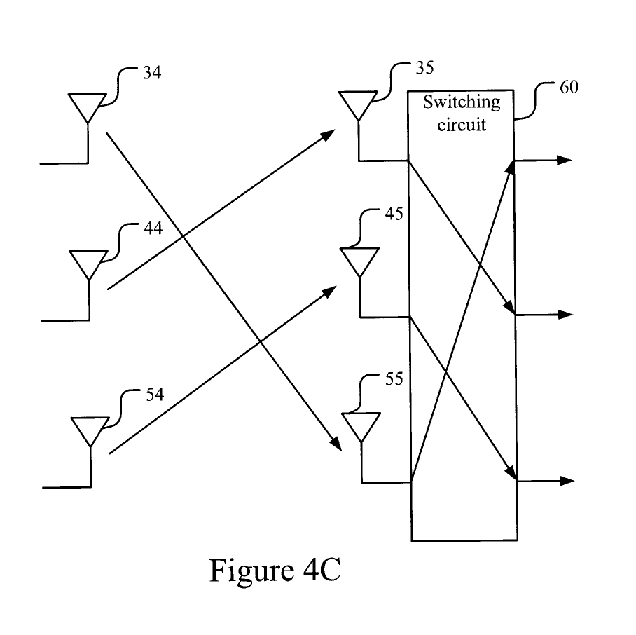

FIGS. 4A to 4C show the schematic diagrams of MIMO data transmission according to the present invention. As shown in the figures, when transmission is performed using the first to the fourth piconets, because the frequency-hopping bands of the transmission antennas of the MIMO system do not interference with each other, people can control the frequency-hopping sequence of the wireless receiving system to acquire the echo of independent data in the space. On the other hand, when transmission is performed using the fifth to the seventh piconets, because the bands of the RF signals transmitted by the plurality of transmitting antennas 34, 44, 54 and of receiving antennas 35, 45, 55 for receiving data are the same, such transmission method will give spatial diversity gains. The receiving frequency-hopping sequence according to the present invention can be divided into parallel hopping MIMO receiving system and switching hopping MIMO receiving system. In the following, the first piconet is used as an example for description. FIG. 4A shows the schematic diagram of a parallel hopping receiving system. The receiving frequency-hopping sequence is:

p1(n)=q1(n), p2(n)=q2(n), p3(n)=q3(n), n=1, 2, 3, . . .
where q1(n) is the first transmitting antenna 34, q2(n) is the second transmitting antenna 44, q3(n) is the third transmitting antenna 54, p1(n) is the first receiving antenna 35, p2(n) is the second receiving antenna 45, and p3(n) is the third receiving antenna 55. The first, the second, and the third transmitting antennas 34, 44, 54 transmit the RF signals to the first, the second, and the third receiving antennas 35, 45, 55 correspondingly and respectively. In addition, the switching circuit 60 is configured as parallel input and output for acquiring the effects of high-speed transmission and diversity of frequency hopping between fixed antennas.

The transmission method of a switching hopping MIMO receiving system is that for every symbol, different receiving antenna is switched to receive the data transmitted by the transmitting antenna, and switch to the original independently received data using the switching circuit 60. That is, switch the received data to the plurality of demodulation units 38, 48, 58 corresponding to the RF signals transmitted by the plurality of RF circuits 33, 43, 53 for demodulating the received data. In addition to high-speed transmission, this transmission method can also acquire the effects of diversity in space and band switching. Take the first piconet for example, the frequency-hopping sequence for receiving is:

$${p}_{1} ( n ) = \{ \begin{matrix}{q}_{1} ( n ) , & n = 1 , 4 , 7 , … \\ {q}_{3} ( n ) , & n = 2 , 5 , 8 , … \\ {q}_{2} ( n ) , & n = 3 , 6 , 9 , …\end{matrix} \\ {p}_{2} ( n ) = \{ \begin{matrix}{q}_{2} ( n ) , & n = 1 , 4 , 7 , … \\ {q}_{1} ( n ) , & n = 2 , 5 , 8 , … \\ {q}_{3} ( n ) , & n = 3 , 6 , 9 , …\end{matrix} \\ {p}_{3} ( n ) = \{ \begin{matrix}{q}_{3} ( n ) , & n = 1 , 4 , 7 , … \\ {q}_{2} ( n ) , & n = 2 , 5 , 8 , … \\ {q}_{1} ( n ) , & n = 3 , 6 , 9 , …\end{matrix}$$

When a first symbol is transmitted (as shown in FIG. 4A), the first receiving antenna 35, the second receiving antenna 45, and the third receiving antenna 55 receive the data transmitted by the first transmitting antenna 34, the second transmitting antenna 44, and the third transmitting antenna 54, respectively. When a second symbol is transmitted (as shown in FIG. 4B), the first receiving antenna 35, the second receiving antenna 45, and the third receiving antenna 55 receive the data transmitted by the third transmitting antenna 54, the first transmitting antenna 34, and the second transmitting antenna 44, respectively. When a third symbol is transmitted (as shown in FIG. 4C), the first receiving antenna 35, the second receiving antenna 45, and the third receiving antenna 55 receive the data transmitted by the second transmitting antenna 44, the third transmitting antenna 54, and the first transmitting antenna 34, respectively. Thereby, when the first, the fourth, the seventh, etc., symbols of the frequency-hopping sequence of the piconet are to be transmitted, the transmission method in FIG. 4A is adopted. Likewise, when the second, the fifth, the eighth, etc., symbols of the frequency-hopping sequence of the piconet are to be transmitted, the transmission method in FIG. 4B is adopted; and when the third, the sixth, the ninth, etc., symbols of the frequency-hopping sequence of the piconet are to be transmitted, the transmission method in FIG. 4C is adopted.

Because it is necessary to be compatible with the SISO MB-OFDM system, after the switching hopping is received, it is necessary to switch back to the original transmitting antenna used for transmitting the RF signals. Hence, the switching circuit 60 switches the received data to the plurality of demodulation units 38, 48, 58 corresponding to the RF signals transmitted by the plurality of RF circuits 33, 43, 53 for demodulating the received data (as shown in FIGS. 4B and 4C).

To sum up, the multiple-input-multiple-output (MIMO) wireless transmission system and the transmission method thereof according to the present invention uses a selection signal of a piconet to determine whether the spatial multiplexing or the spatial reuse method is adopted by the first processing unit to drive the plurality of RF circuits for transmitting the RF signals to the wireless receiving system in a switching or in a parallel fashion. In the spatial multiplexing method, each antenna transmits data in a different band and hence features spatial frequency-hopping multiplexing characteristics. Thereby, high-speed transmission is achieved and the circuit area is reduced.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A multiple-input-multiple-output (MIMO) wireless transmission system, comprising:
a wireless transmitting system, comprising:
an encoding unit, receiving input data, and encoding the input data to produce encoded data;
a first processing unit, receiving the encoded data, processing the encoded data, and outputting the encoded data;
a plurality of modulation units, receiving the encoded data output by the first processing unit, and modulating the encoded data to produce a plurality of modulated data;
a plurality of first conversion units, coupling to the plurality of modulation units, respectively, receiving the plurality of modulated data, and converting the plurality of modulated data to a plurality of transmitting signals; and
a plurality of radio-frequency (RF) circuits, coupling to the plurality of first conversion units, respectively, receiving the plurality of transmitting signals, converting the plurality of transmitting signals to a plurality of RF signals, and transmitting the RF signals according to the frequency-hopping sequence of a piconet, respectively;
a wireless receiving system, comprising:
a plurality of receiving processing units, receiving the RF signals according to the frequency-hopping sequence of the piconet of the plurality of RF circuits, respectively;
a plurality of second conversion units, coupling to the plurality of receiving processing units, respectively, receiving the RF signals, and converting the RF signals to received data;
a switching circuit, switching the received data;
a plurality of demodulation units, receiving the received data switched by the switching circuit, and demodulating the received data to produce demodulated data;
a second processing unit, receiving the demodulated data, and processing the demodulated data to output the demodulated data; and
a decoding unit, decoding the demodulated data output by the second processing unit to produce output data.

2. The wireless transmission system of claim 1, wherein the first processing unit adopts spatial multiplexing to process the encoded data and outputs the encoded data.

3. The wireless transmission system of claim 2, wherein the first processing unit is a demultiplexer, which adopts spatial multiplexing to process the encoded data and outputs the encoded data.

4. The wireless transmission system of claim 2, wherein when the first processing unit processes the encoded data using spatial multiplexing, the plurality of RF circuits transmits switchingly the RF signals to the plurality of receiving processing units according to the different bands of the frequency-hopping sequence of the piconet, respectively.

5. The wireless transmission system of claim 2, wherein the second processing unit is a multiplexer, which restores spatial multiplexing and processes the demodulated data to output the demodulated data.

6. The wireless transmission system of claim 1, wherein the first processing unit adopts the spatial reuse process to process the encoded data and outputs the encoded data.

7. The wireless transmission system of claim 6, wherein the first processing unit transmits simultaneously the encoded data to the plurality of modulation units, processes the encoded data with the spatial reuse method, and outputs the encoded data.

8. The wireless transmission system of claim 6, wherein when the first processing unit processes the encoded data with the spatial reuse method, the plurality of RF circuits transmits in parallel the RF signals to the plurality of receiving processing unit in the same band.

9. The wireless transmission system of claim 6, wherein the second processing unit is a synthesis unit, which restores the spatial reuse process and processes the demodulated data to output the demodulated data.

10. The wireless transmission system of claim 1, wherein the first processing unit further receives a selection signal, processes the encoded data using the spatial multiplexing or the spatial reuse method, and outputs the encoded data.

11. The wireless transmission system of claim 8, wherein the selection signal is a selection signal of a piconet.

12. The wireless transmission system of claim 1, wherein the first conversion unit is a digital-to-analog converter for converting the digital modulated data to the analog RF signals.

13. The wireless transmission system of claim 1, wherein the plurality of RF circuits further includes a transmitting antenna for transmitting the RF signals to the wireless receiving system.

14. The wireless transmission system of claim 1, wherein the modulation units are orthogonal frequency-division multiplexing (OFDM) modulation units.

15. The wireless transmission system of claim 1, wherein the switching circuit switches the received data to the plurality of modulated units corresponding to the plurality of RF circuits according to the RF signals transmitted by the plurality of RF circuits of the wireless transmitting system for demodulating the received data.

16. The wireless transmission system of claim 1, wherein the plurality of receiving processing units further includes a plurality of receiving antennas, coupling to the plurality of receiving processing units, respectively, for receiving the RF signals and transmitting to the plurality of receiving processing units.

17. The wireless transmission system of claim 1, wherein the second conversion unit is an analog-to-digital converter for converting the analog RF signals to the digital received data.

18. The wireless transmission system of claim 1, wherein the demodulation units are orthogonal frequency-division multiplexing (OFDM) demodulation units.

19. A method for multiple-input-multiple-output (MIMO) wireless transmission, comprising the steps of:
encoding input data to produce encoded data;
receiving the encoded data, processing the encoded data, and outputting the encoded data;
receiving the processed encoded data, and modulating the encoded data to produce a plurality of modulated data;
receiving the plurality of modulated data, and converting the plurality of modulated data to a plurality of transmitting signals;
receiving the plurality of transmitting signals, converting the plurality of transmitting signals to a plurality of RF signals, and transmitting the RF signals according to the frequency-hopping sequence of a piconet, respectively;
receiving the RF signals according to the frequency-hopping sequence of the piconet, respectively;
converting the RF signals to received data;
switching the received data according to a selection signal;
receiving the switched received data, and demodulating the received data to produce demodulated data;
receiving the demodulated data, and processing the demodulated data to output the demodulated data; and
decoding the converted demodulated data to produce output data.
